(19) United States
(12) Patent Application Publication
(10) Pub. No.: US 2013/0181892 A1
(43) Pub. Date: Jul. 18, 2013

(54) Image Adjusting

(71) Applicants: Pasi Petteri Liimatainen, Lempaala (FI); Matti Sakari Hamalainen, Lempaala (FI)

(72) Inventors: Pasi Petteri Liimatainen, Lempaala (FI); Matti Sakari Hamalainen, Lempaala (FI)

(73) Assignee: Nokia Corporation

(21) Appl. No.: 13/349,950

(22) Filed: Jan. 13, 2012

(51) Int. Cl. G09G 5/00

(52) U.S. Cl. 345/156

(57) ABSTRACT

An apparatus including a display configured to display an image; and a system for adjusting the image on the display based upon location of a user of the apparatus relative to the apparatus. The system for adjusting includes a camera and an orientation sensor. The system for adjusting is configured to use signals from both the camera and the sensor to determine the location of the user relative to the display.

### BACKGROUND

1. Technical Field

The exemplary and non-limiting embodiments relate generally to a display and, more particularly, to adjusting an image on a display.

2. Brief Description of Prior Developments

3D (three dimensional) displays are known for displaying stereoscopic images. Some 3D displays require use of special headgear or glasses to properly see the 3D image. Autosteroscopy displays, also called “glasses-free 3D” or “glassesless 3D”, do not require special 3D glasses for 3D image viewing. There are two broad approaches currently used to accommodate motion parallax and wider viewing angles: eye-tracking, and multiple views so that the display does not need to sense where the viewers' eyes are located. Examples of autostereoscopic displays include parallax barrier, lenticular, volumetric, electro-holographic, and light field displays.

### SUMMARY

The following summary is merely intended to be exemplary. The summary is not intended to limit the scope of the claims.

In accordance with one aspect, an apparatus is provided including a display configured to display a 3D image; and a system for adjusting the 3D image on the display based upon location of a user of the apparatus relative to the apparatus. The system for adjusting includes a camera and an orientation sensor. The system for adjusting is configured to use signals from both the camera and the sensor to determine the location of the user relative to the display.

In accordance with another aspect, an example method comprises tracking a user by a camera; determining orientation of the camera and/or motion of the camera relative to the user; and based upon both the tracking and the determining, adjusting a 3D image on a display.

In accordance with another aspect, a non-transitory program storage device readable by a machine, tangibly embodying a program of instructions executable by the machine for performing operations is provided, the operations comprising estimating location of a user comprising tracking the user by a camera, and determining orientation of the camera and/or motion of the camera relative to the user; and based upon the estimated location of the user, adjusting a 3D image on a display.

In accordance with another aspect, an example method comprises tracking a user by a camera; determining orientation of the camera and/or motion of the camera relative to the user; and estimating location of the user relative to a display based upon both the tracking and the determining.

### BRIEF DESCRIPTION OF THE DRAWINGS

The foregoing aspects and other features are explained in the following description, taken in connection with the accompanying drawings, wherein:

FIG. 1 is a perspective view of an example embodiment;

FIG. 2 is a diagram illustrating some of the components of the apparatus shown in FIG. 1;

FIG. 3 is a diagram illustrating an adjustment system used in the apparatus shown in FIG. 1;

FIGS. 4A-4F illustrate different positions or locations of a user relative to the display shown in FIG. 1;

FIG. 5 is a diagram illustrating some steps of an example method;

FIG. 6 is a diagram illustrating some steps of an example method;

FIG. 7 is a diagram illustrating some steps of an example method;

FIG. 8 is a diagram illustrating some steps of an example method; and

FIG. 9 is a diagram illustrating some steps of an example method.

### DETAILED DESCRIPTION OF EMBODIMENTS

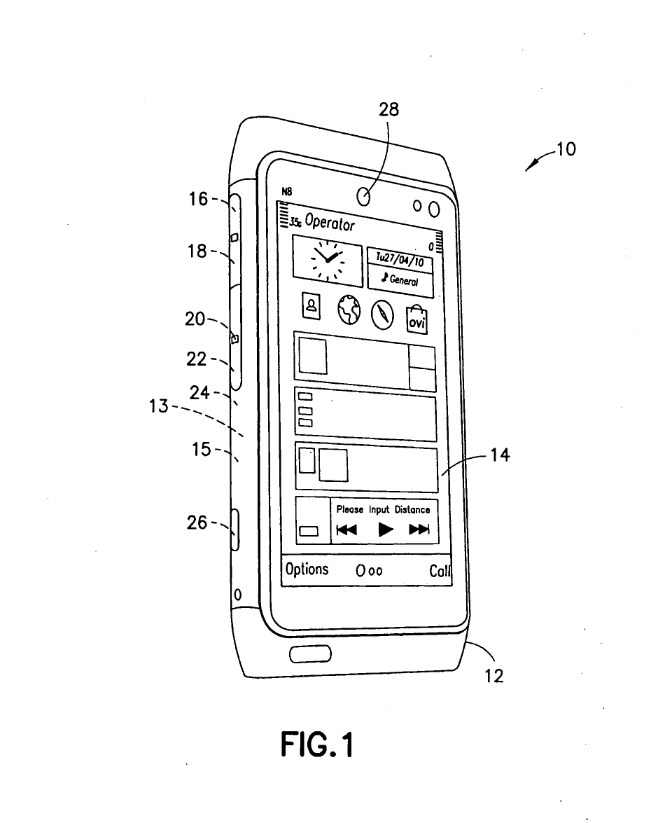

Referring to FIG. 1, there is shown a perspective view of an apparatus 10 according to an example embodiment. In this example the apparatus 10 is a hand-held portable apparatus comprising various features including a telephone application, Internet browser application, camera application, video recorder application, music player and recorder application, email application, navigation application, gaming application, and/or any other suitable electronic device application. The apparatus may be any suitable portable electronic device, such as a mobile phone, computer, laptop, PDA, etc. for example.

The apparatus 10, in this example embodiment, comprises a housing 12, a touch screen display 14 which functions as both a display and a user input, and electronic circuitry 13 including a printed wiring board 15 having at least some of the electronic circuitry thereon. The display 14 need not be a touch screen. The electronic circuitry can include, for example, a receiver 16, a transmitter 18, and a controller 20. The controller 20 may include at least one processor 22, at least one memory 24, and software. A rechargeable battery 26 is also provided.

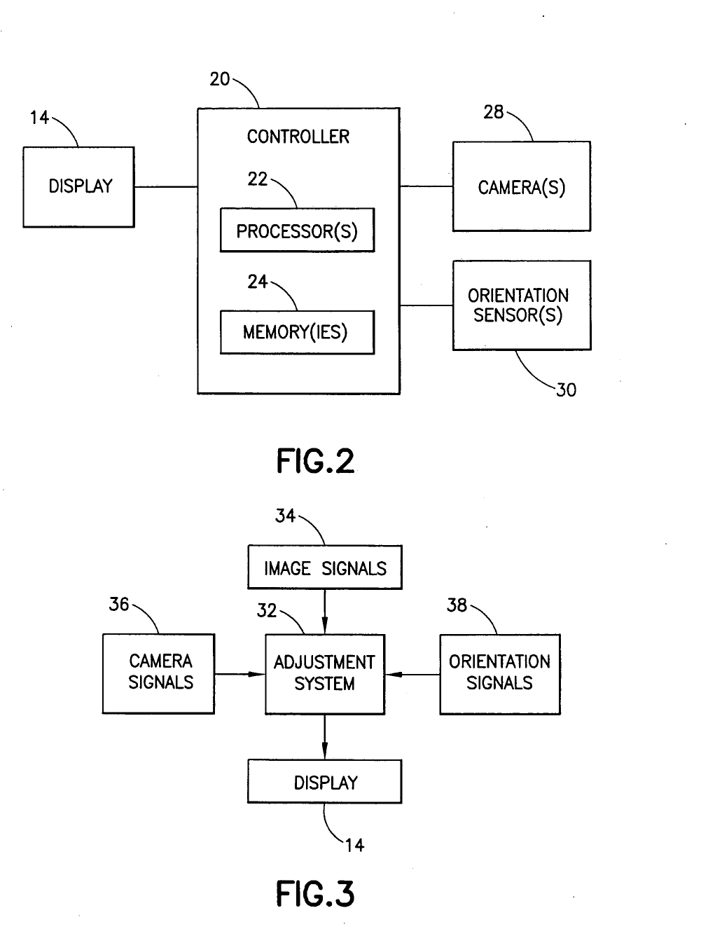

Referring also to FIG. 2, the display 14 is connected to the controller 20. The controller 20 is configured to send image signals to the display 14 for displaying the images on the display. In this example the display 14 is a 3D display, such as an autosteroscopic display for example. The display is configured to display stereoscopic images for viewing by the user, such as autosteroscopic images for viewing without 3D glasses and/or non-autosteroscopic images which require 3D glasses. The display 14 can also display 2D images as well.

The apparatus 10 also includes at least one camera 28 and at least one orientation sensor 30. In this example the camera 28 is a front camera facing the same direction as the display 14. The camera 28 is a conventional camera generally known in mobile telephones for example. Thus, the camera can generally see the user while the user is looking at the display 14. The orientation sensor(s) 30 can include motion sensors such as an acceleration sensor, or an impulse sensor, or a vertical or horizontal sensor, for example, which are generally known in hand held gaming devices and computer tables for example. As seen in FIG. 2, the camera 28 and the orientation sensor 30 are connected to the controller 20.

Referring also to FIG. 3, the controller 20 comprises an adjustment system 32. The adjustment system 32 is configured to adjust the display of 3D images on the display 14. As noted above, the display 14 is a 3D display adapted to display stereoscopic images. For certain stereoscopic images, such as on an autosteroscopic display for example, for a better viewing experience the image is adjusted based upon location of the user's head or face or eyes relative to the display. This may also be the case for an advanced non-autosteroscopic display which needs to track the user's head or face or eyes relative to the display. The adjustment system 32 accomplishes this adjustment. In particular, the adjustment system 32 takes the image signals 34 and adjusts delivery of the image signals to the display 14. In this example, the adjustment system 32 uses camera signals 36 from the camera(s) 28 and orientation signals 38 from the orientation sensor(s) 30.

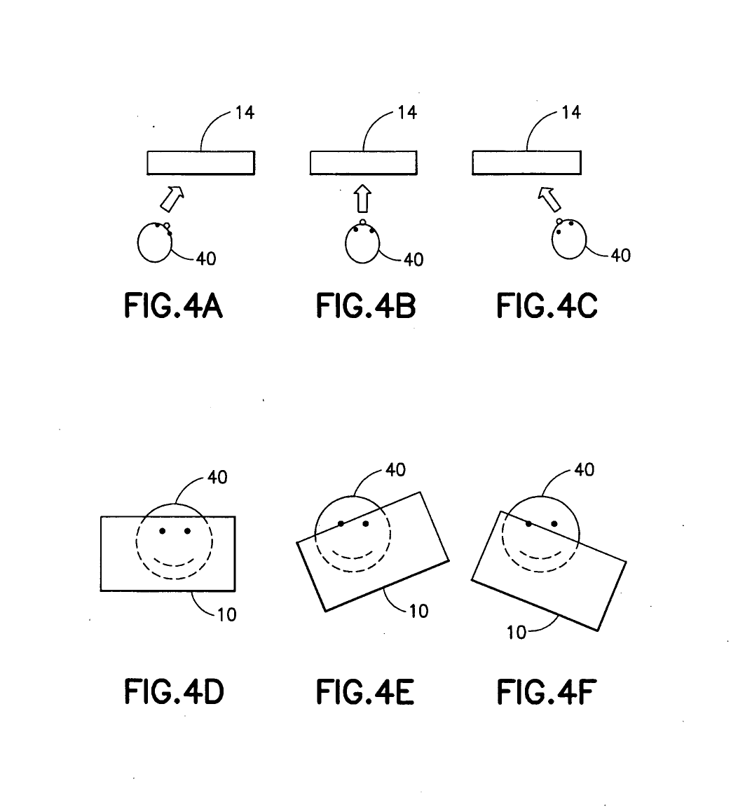

Referring also to FIGS. 4A-4C, when the user 40 is directly in front of the display 14 as shown in FIG. 4B, the 3D images will be displayed on the display 14 a first way. When the user 40 is to the left of the display 14 as shown in FIG. 4A, the 3D images will be displayed on the display 14 a second way. When the user 40 is to the right of the display 14 as shown in FIG. 4C, the 3D images will be displayed on the display 14 a third way. Referring also to FIGS. 4D-4F, even if the user is directly in front of the display 14, the user can be holding the apparatus with different pitch, yaw and roll FIGS. 4D-4F illustrate varying yaw such as during a race car driving game when the user uses the apparatus 10 similar to a steering wheel. The description with regard to FIGS. 4A-4F is merely an example to help understand that, in order for the user 40 to view the best 3D image from the display 14, the images on the display may need to be adjusted based upon the relative position of the user 40 relative to the display 14.

In the past, signals from the camera alone were used to track the location of the user relative to the display. The controller would track the user's head/face/eyes based upon these camera signals. However, this type of tracking using only camera signals requires a lot of computer processing. This processing uses electricity and, in a battery operated hand-held device, can quickly drain the battery.

The system shown in the drawings can operate in a tracking mode which does not use only camera signals. In particular, the adjustment system 32 can use both the camera signals 36 and the orientation signals 38 to track and estimate the location of the user 40 relative to the display 14.

An example system comprises tracking a user of a mobile device with a combination of sensors. The tracking is done with respect to the mobile device; especially its display. Accurate tracking of the user is especially important for improving the user experience of autostereoscopic displays, but can also be used to create advanced 3D user interfaces. User tracking with a front camera of a mobile device (the camera facing the same direction as the display) normally has two main problems: processing the video stream from the camera is computationally intensive which reduces the mobile device's battery life, and a standard mobile device front camera has a limited field of view which may sometimes easily put the user's face out of the frame. This is clearly evident where the mobile device is moved often, such as with some game applications for example where the device's orientation sensors are used to control an application, e.g. a racing game.

The features described above can combine the information from the front camera and the device's orientation sensors to track and estimate the user's location with respect to the device. The data sources are fused to yield an accurate real-time estimate of the user's position even when individual source frequency from the source 28 might be low or missing at times. The device's front facing camera 28 may be used in a low frame rate mode to detect the user's face. This establishes the “ground truth” for the user's head location. The device's orientation sensors are used to provide a higher frequency stream of readings of the device's orientation. When combined, the following benefits are gained:
The frequency of camera based detections can be kept low in order to reduce processing power requirements and, thus, battery consumption can be lowered. Between these low frequency detections, the orientation sensors are used to provide information on the relative movement of the device.
The user can be tracked by estimation even after the device has been rotated so much that the user is not in the field of view of the camera anymore (e.g. due to the user using the device to control a game); such as by continuing tracking only based on orientation sensors when the camera doesn't provide face detections.
The fused user position information can then be used, such as to eliminate autostereoscopic display artifacts or to drive a user interface (UI).

Information can be combined from the front camera and the device's orientation sensors to track and estimate the user's location with respect to the device in a power efficient way. This allows for advanced control of the update rate of the user and device tracking (hereafter “sampling frequency”) of the various sensing subsystem (especially the camera) to work well in various usage situations. Different sensing subsystems (such as camera, orientation, etc.) have different processing load and latency characteristics, and the combination of multiple sensor types enables more optimal system level performance compared to single sensing method (e.g. camera tracking alone). Additionally, the relative orientation changes caused by device movements can be much faster than the user movements (without device movement) setting different technical requirements for different sensing subsystems.

With features described above, the tracking can be done by reducing the frequency of camera based user detection (or tracking). In other words, output from the camera can be sampled at a reduced rate, and this reduced rate sampling can be used as one of the inputs for the recognition software and adjusting system. This provides a much more power efficient manner of tracking the user than merely using input from the camera alone. As an example, even though the camera may be able to take images at 30 frames per second, the adjusting system could be configured to use less than the 30 frames per second. For example, the sampling rate might only use 1 frame per second, or 1 frame every two seconds. This sampling results in the processor 22 having to perform less recognitions per time period and, thus, uses less battery power than conventional systems.

The less than full use of the frame-per-second output from the camera does not need to be static. It could be variably by the user and/or automatically by the apparatus. For example the user and/or apparatus could select a sampling rate of 1 frame per second even though the camera output is 30 frames per second. The user and/or apparatus could then change this 1 frame per second setting to a larger sampling rate or smaller sampling rate, such as 10 frames per second or 1 frame every 2 seconds for example. This can be done manually and/or automatically. This could be done automatically based upon a predetermined event and/or the signal from the other sensor(s), such as the orientation sensor(s) 30.

Features described above allow enabling expansion of the tracked area beyond the limits of the camera's field of view by continuing tracking via estimation with orientation sensors; even when the user is not in the camera's view. For example, as seen in FIGS. 4E and 4F, when the user moves the apparatus 10, the face or eye might no longer be in the field of view of the camera. Thus, the recognition software may no longer be able to determine where the user's head/face/eyes are relative to the display 14 at certain instances. The additional sensor(s), such as orientation sensor(s) 30, can be used to estimate where the user's head/face/eyes are relative to the display.

Conventional continuous camera head/face/eye tracking technologies consume much more processing power than reading a power efficient orientation sensor 30, even if the camera recognition sensor system utilizes advanced sensor fusion algorithms. Data bandwidth for processing 1-D orientation sensor signals 38 consumes less power than processing a 3D video stream 36. The orientation sensor signal 38 can also be analyzed asynchronically relying on interrupts by triggering the orientation sensing, such as with an accelerometer for example, whereas conventional continuous camera tracking needs to sample the entire data and process the necessary analysis before orientation sensing can be performed. Triggering can be utilized e.g. in the form of a sleep state.

Integration of multiple sensing subsystems into one adjusting system 32 also enables sensor calibration data as a by-product of the analysis. It is possible to collect orientation sensor drifting statistics by monitoring the movement of background scene with a camera sensor and, when the camera is detected to be stationary (e.g. laying on the table), the orientation sensor statistics can be collected for the optimization of processing algorithms attenuating sensing noise.

A system may be provided for processing in a power efficient way to determine the position of the user with respect to the device. A system may be provided for enabling higher frequency user tracking than feasible with camera based face or eye tracking by fusing lower frequency “absolute” position from face detection with higher frequency relative orientation sensor readings. A system may be provided for distinguish between the user moving with the device and the user rotating the device (with respect to the user). A system may provide additional information about the device usage context by re-using the output from different sensing subsystems. For example by detecting the state when the device is held in a hand compared to laying on a fixed surface, or monitoring user behavior if he/she is looking at the screen, and this way able to respond to visual feedback. If you know if the user is looking at the screen or able to see the display, this also enables several other methods on how to adapt multimodal user interface in different situations e.g. if we know that user is seeing the visual feedback we do not have to disturb others by playing disturbing sounds when not needed. Even in this case it is possible to have conventional fall back mechanisms in case the user is not reacting to the message as expected.

In one example, an apparatus comprises a display 14 configured to display a 3D image; and a system 32 for adjusting the 3D image on the display based upon location of a user 40 of the apparatus relative to the apparatus. The system for adjusting comprises a camera 28 and an orientation sensor 30. The system 32 for adjusting is configured to use signals 36, 38 from both the camera and the sensor to determine the location of the user relative to the display.

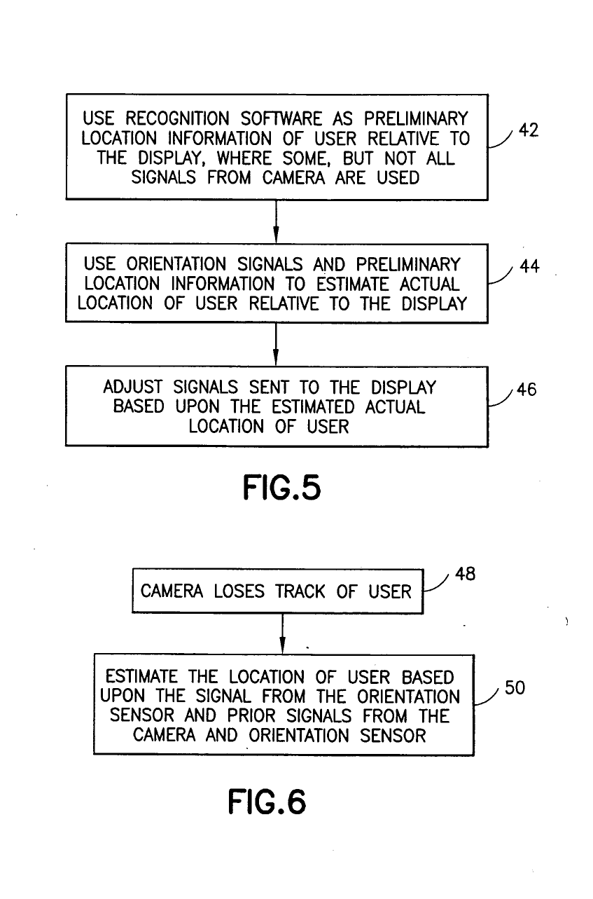

The display 14 may comprise an autosteroscopy display system. The orientation sensor 30 may comprise a motion sensor. The system for adjusting may be configured to track a head, face or eye of a user. Referring also to FIG. 5, in one method the system uses recognition software to determine a preliminary location information of the user relative to the display, where some, but not all signals 36 from camera are used as indicated by block 42. In this method, the system then uses the orientation signals 38 and the preliminary location information to estimate the actual location of user relative to the display at a future time as indicated by block 44. The system then adjusts the signals sent to the display 14 based upon this estimated actual location of the user as indicated by block 46.

Referring also to FIG. 6, in one example method, when the camera loses track of the head, face or eye of the user as indicated by block 48, the system for adjusting is configured to estimate the location of the head, face or eye based upon the signal from the orientation sensor and prior signals from the camera and/or orientation sensor as indicated by block 50.

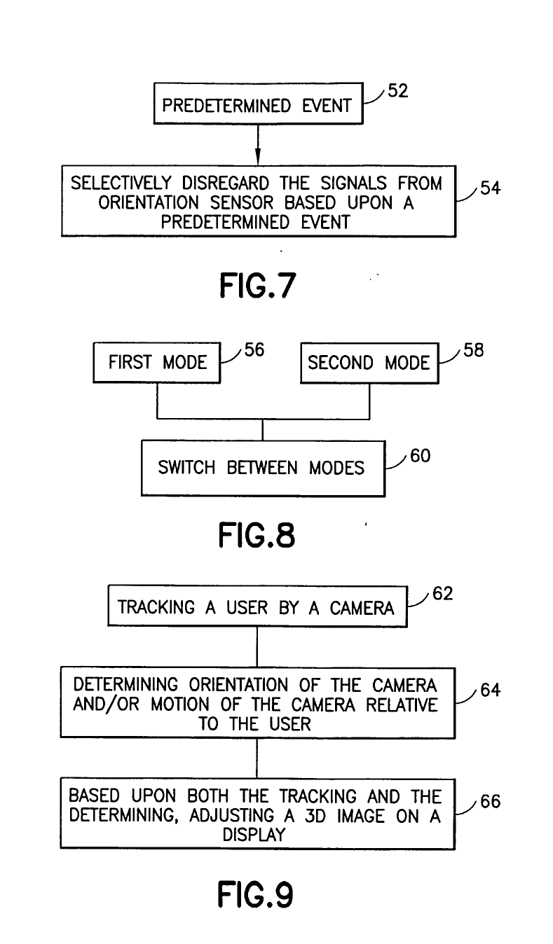

Referring also to FIG. 7, the system for adjusting 32 may be configured to selectively disregard the signals from the orientation sensor as indicated by block 54 based upon a predetermined event 52. The predetermined event may comprise, for example, the user 40 selecting a setting on the apparatus 10 for the system for adjusting to disregard the signals 38 from the orientation sensor. A user might do this, for example, while travelling on a very bumpy train ride.

Referring also to FIG. 8, the system for adjusting 32 may comprise a first mode 56 comprising use of the signals 36 from the camera and the signals 38 from the orientation sensor as described above with respect to FIG. 5, and a second mode 58 which does not comprise use of the signals 38 from the orientation sensor. For example, the second mode 58 could use the conventional system of only using signals from the camera to track the user. As indicated by block 60 the user and/or the apparatus 10 could control switching between the two modes 56, 58. In one type of example, normally the apparatus would be set to the first mode 56. However, when the user encounters the very bumpy train ride situation described above, the user could switch the apparatus to the second mode (or perhaps the apparatus could automatically switch to the second mode based upon the frequency of the bumps). Likewise, the user could switch back to the first mode, or the apparatus could be configured or programmed to automatically switch back to the first mode, such as after a predetermined amount of time or if the frequency of the bumps diminishes to a predetermined level. This is, of course, merely an example. Any suitable programming could be provided to automatically switch between the various different modes.

The orientation sensor 30 may comprise multiple sensors, and the system for adjusting may be configured to selectively disregard the signals from one of the orientation sensors based upon a predetermined event. The system for adjusting 32 may be configured to use different update rates of the signals 36 from the camera based upon the signals from the orientation sensor. For example, if the orientation signals do not change over a period of one minute, the update rate of the signals 36 from the camera might be reduced to only once every 15 seconds. If a change in orientation signal comes in at an interval of 1 second, the update rate of the signals 36 from the camera might be increase to once every 0.5 seconds. This is merely an example. Any suitable update rates could be provided.

With the systems and methods described above, means for estimating the location of the user may be provided based upon the signals from the camera and orientation sensor. The apparatus may be a hand-held portable device with the camera, the display and the orientation sensor thereon. In a different type of apparatus, the camera and/or the display and/or the orientation sensor may be separate from each other, such as in separate, spaced housings for example. For example, in an airplane the display and camera might be on the back of the seat in front of the user. However, one of the orientation sensors might be a gyroscope of the airplane. In another example, in an amusement park ride one of the orientation sensors could be in a motion seat which the user is sitting in.

Referring also to FIG. 9, an example method comprises tracking a user by a camera as indicated by block 62; determining orientation of the camera and/or motion of the camera relative to the user as indicated by block 64; and based upon both the tracking and the determining, adjusting a 3D image on a display as indicated by block 66. Tracking the user may comprise the camera tracking a head or face or an eye of the user. When the camera loses track of the head, face or eye of the user, the method may estimate location of the head, face or eye based upon the determined orientation and/or motion, and prior signals from the camera. Adjusting the 3D image on the display may comprise adjusting the 3D image on an autosteroscopy display system. The method may further comprise, in adjusting the 3D image on the display, selectively disregarding the determined orientation of the camera and/or motion of the camera relative to the user based upon a predetermined event. The predetermined event may comprise the user selecting a setting on an apparatus for the adjusting step to disregard signals from an orientation sensor. Adjusting the 3D image on the display may comprise a first mode comprising use of signals from the camera and an orientation sensor, and a second mode which does not comprise use of the signals from the orientation sensor and/or from the camera. Determining orientation and/or motion may comprise use of multiple sensors, and selectively disregarding signals from one of the orientation sensors based upon a predetermined event. Adjusting the 3D image may comprise use of different update rates of signals from the camera based the determined orientation and/or motion of the camera.

In one example, a non-transitory program storage device readable by a machine, tangibly embodying a program of instructions executable by the machine for performing operations is provided, such as in the memory 24 or a CD-ROM or a memory module for example, where the operations comprise estimating location of a user comprising tracking the user by a camera, and determining orientation of the camera and/or motion of the camera relative to the user; and based upon the estimated location of the user, adjusting a 3D image on a display.

An example method comprises tracking a user by a camera; determining orientation of the camera and/or motion of the camera relative to the user; and estimating location of the user relative to a display based upon both the tracking and the determining. A hand-held apparatus may comprises a plurality of sensors for determining the orientation of the camera and/or the motion of the camera relative to the user, and the hand-held apparatus also comprises the camera and the display.

Besides the camera signals 36 and the orientation sensor signals 38, the adjustment system 32 may also use signals such as relating to velocity of the apparatus, such as GPS signals and/or signals from base stations to indicate velocity. A signal from a hand sensor (such as adapted to sense whether or not a user is holding the apparatus 10 in the user's hand) could also be used. Thus, the adjusting system 32 could use more than the camera signals 36 and the orientation sensor signals 38 to track and estimate the user location relative to the display, or adjust the 3D image at the display 14, or to increase or decrease the update rate relating to the camera signal sampling used for tracking.

Although the above description of example embodiments is in regard to 3D applications, features could also be use in non-3D applications, such as a normal 2D display for example. In such an example the user interface (UI) presented on the 2D display can be adjusted based on the user's position (such as for applications with motion parallax or head coupled perspective for example).

It should be understood that the foregoing description is only illustrative. Various alternatives and modifications can be devised by those skilled in the art. For example, features recited in the various dependent claims could be combined with each other in any suitable combination(s). In addition, features from different embodiments described above could be selectively combined into a new embodiment. Accordingly, the description is intended to embrace all such alternatives, modifications and variances which fall within the scope of the appended claims.

What is claimed is:

1. An apparatus comprising:
a display configured to display an image; and
a system for adjusting the image on the display based upon location of a user of the apparatus relative to the apparatus, where the system for adjusting comprises a camera and an orientation sensor, where the system for adjusting is configured to use signals from both the camera and the sensor to determine the location of the user relative to the display.

2. An apparatus as in claim 1 where the display comprises an autosteroscopy display system.

3. An apparatus as in claim 1 where the orientation sensor comprises a motion sensor.

4. An apparatus as in claim 1 where the system for adjusting is configured to track a head of the user or an eye of a user and, when the camera loses track of the head or eye of the user, the system for adjusting is configured to estimate the location of the head or eye based upon the signal from the orientation sensor and prior signals from the camera and orientation sensor.

5. An apparatus as in claim 1 where the system for adjusting is configured to selectively disregard the signals from the orientation sensor based upon a predetermined event.

6. An apparatus as in claim 5 where the predetermined event comprises the user selecting a setting on the apparatus for the system for adjusting to disregard the signals from the orientation sensor.

7. An apparatus as in claim 1 where the system for adjusting comprises a first mode comprising use of the signals from the camera and the orientation sensor, and a second mode which does not comprise use of the signals from the orientation sensor.

8. An apparatus as in claim 1 where the orientation sensor comprises multiple sensors, and where the system for adjusting is configured to selectively disregard the signals from one of the orientation sensors based upon a predetermined event.

9. An apparatus as in claim 1 where the system for adjusting is configured to use different update rates of the signals from the camera based upon the signals from the orientation sensor.

10. An apparatus as in claim 1 where the system for adjusting comprises means for estimating the location of the user based upon the signals from the camera and orientation sensor.

11. An apparatus as in claim 1 where the apparatus is a hand-held portable device with the camera, the display and the orientation sensor thereon.

12. A method comprising:
tracking a user by a camera;
determining orientation of the camera and/or motion of the camera relative to the user; and
based upon both the tracking and the determining, adjusting an image on a display.

13. A method as in claim 12 where tracking the user comprises the camera tracking a head or an eye of the user.

14. A method as in claim 13 where, when the camera loses track of the head or eye of the user, adjusting comprises estimating location of the head or eye based upon the determined orientation and/or motion, and prior signals from the camera.

15. A method as in claim 12 where adjusting the image on the display comprises adjusting the image on an autosteroscopy display system.

16. A method as in claim 12 further comprising, in adjusting the image on the display, selectively disregarding the determined orientation of the camera and/or motion of the camera relative to the user based upon a predetermined event.

17. A method as in claim 12 where the predetermined event comprises the user selecting a setting on an apparatus for adjusting to disregard signals from an orientation sensor.

18. A method as in claim 12 where adjusting the image on the display comprises a first mode comprising use of signals from the camera and an orientation sensor, and a second mode which does not comprise use of the signals from the orientation sensor and/or from the camera.

19. A method as in claim 12 where determining orientation and/or motion comprises use of multiple sensors, and selectively disregarding signals from one of the orientation sensors based upon a predetermined event.

20. A method as in claim 12 where adjusting the image comprises use of different update rates of signals from the camera based the determined orientation and/or motion of the camera.

21. A method as in claim 12 where the image is a 3D image, and where adjusting the image on the display comprises adjusting the 3D image on the display based upon both the tracking and the determining.

22. A non-transitory program storage device readable by a machine, tangibly embodying a program of instructions executable by the machine for performing operations, the operations comprising:
estimating location of a user comprising tracking the user by a camera, and determining orientation of the camera and/or motion of the camera relative to the user; and
based upon the estimated location of the user, adjusting an image on a display.

23. A method comprising:
tracking a user by a camera;
determining orientation of the camera and/or motion of the camera relative to the user; and
estimating location of the user relative to a display based upon both the tracking and the determining.

24. A method as in claim 23 where a hand-held apparatus comprises a plurality of sensors for determining the orientation of the camera and/or the motion of the camera relative to the user, and the hand-held apparatus also comprises the camera and the display.
